(19) United States
(12) Patent Application Publication
(10) Pub. No.: US 2010/0261094 A1
(43) Pub. Date: Oct. 14, 2010

(54) Apparatus for containing metal-organic frameworks

(75) Inventors: Ming Sheng Yu, Taipei City (TW); Cheng Yu Wang, Longtan Shiang (TW); Hsiu Chu Wu, Longtan Shiang (TW); Pin Yen Liao, Hualien City (TW); Yun Hwa Hwang, Yangmei Town (TW); Che Chung Lai, Longtan Shiang (TW); Yan Hwui Wu, Zhongli City (TW)

Correspondence Address: Jackson Intellectual Property Group PLLC, 106 Starvale Lane, Shipman, VA, 22971, US

(73) Assignee: ATOMIC ENERGY COUNCIL - INSTITUTE OF NUCLEAR ENERGY RESEARCH, Taoyuan (TW)

(21) Appl. No.: 11/987,399

(22) Filed: Nov. 29, 2007

(51) Int. Cl. H01M 8/04

(52) U.S. Cl. 429/515

(57) ABSTRACT

An apparatus is disclosed for containing metal-organic frameworks for storing hydrogen for use in a fuel cell. The apparatus includes a cartridge for containing the metal-organic frameworks, a filter connected to the cartridge for filtering out powder of the metal-organic frameworks during the release of the hydrogen, a ball valve connected to the filter for controlling the travel of the hydrogen, a pressure regulator connected to the ball valve for regulating the pressure of the hydrogen, a flow controller connected to the pressure regulator for controlling the flow rate of the hydrogen and a pipe connected to the flow controller on one hand and connected to the fuel cell on the other hand for providing the hydrogen to the fuel cell. The flow controller includes a flow meter for showing the flow rate of the hydrogen and a needle valve operable for changing the flow rate of the hydrogen.

### FIELD OF THE INVENTION

The present invention relates to a fuel cell and, more particularly, to an apparatus for containing metal-organic frameworks for storing hydrogen for use in a fuel cell.

### DESCRIPTION OF THE RELATED ARTS

A hydrogen-storing material plays an important role for storing hydrogen for use in a fuel cell. In use, the hydrogen-storing material releases the hydrogen at an electrode of the fuel cell while another electrode of the fuel cell releases oxygen. The hydrogen reacts with the oxygen to convert chemical energy into electric energy. A cartridge is used to store the hydrogen-storing material. The capacity of the cartridge determines the performance of the fuel cell. Different amounts and rates of the release of the hydrogen cause different powers of the electric energy. Different hydrogen-storing materials require different conditions for the absorption and release of the hydrogen. For example, the pressure plateau and temperature required for the absorption of the hydrogen and the pressure plateau and temperature for the release of the hydrogen influence the design and operation of the cartridge.

It requires a lot of resources to develop and produce a cartridge for containing the hydrogen-storing material due to a minimum pressure of 70 MPa that it must stand to increase the density of the hydrogen stored therein, and further in consideration of an estimated safety factor.

Where Mg-based alloy hydride is used to make a cartridge for containing the hydrogen-storing material, the hydrogen is absorbed and released in an appropriate range of temperature between 200 and 300 degrees Celsius. Therefore, there is a need for a heater or heat exchanger to complete the absorption and release of the hydrogen.

Among other hydrogen-storing material, metal-organic frameworks with nanometer pores are popular. The metal-organic frameworks include large specific areas of 1700 to 4500 m²/g. The sizes of the pores are smaller than 2 nm. The volume of the pores takes a large portion of the volume of the metal-organic frameworks. The pores are in communication with one another, thus forming 3-dimensional tunnels. Therefore, the metal-organic frameworks absorb hydrogen based on physical absorption. After bridge-building processes with the introduction of catalysts, glucose and sucrose, the hydrogen-absorption capacity of the cartridge can be as high as 4.7 wt % under 10 MPa.

In general, a metal-organic framework absorbs more hydrogen under a higher pressure and releases the hydrogen under the atmospheric pressure at the normal temperature. However, due to the relation between the hydrogen-absorption capacity and the pressure, the amount and rate of the release of the hydrogen are small when the pressure is low. Therefore, the design and production of the cartridges for containing the metal-organic frameworks must be different from that of the cartridges for containing other hydrogen-storing media.

The present invention is therefore intended to obviate or at least alleviate the problems encountered in prior art.

### SUMMARY OF THE INVENTION

The primary objective of the present invention is to provide an apparatus for containing metal-organic frameworks for storing hydrogen for use in a fuel cell.

To achieve the foregoing objective of the present invention, the apparatus includes a cartridge for containing the metal-organic frameworks, a filter connected to the cartridge for filtering out powder of the metal-organic frameworks during the release of the hydrogen, a ball valve connected to the filter for controlling the travel of the hydrogen, a pressure regulator connected to the ball valve for regulating the pressure of the hydrogen, a flow controller connected to the pressure regulator for controlling the flow rate of the hydrogen and a pipe connected to the flow controller on one hand and connected to the fuel cell on the other hand for providing the hydrogen to the fuel cell. The flow controller includes a flow meter for showing the flow rate of the hydrogen and a needle valve operable for changing the flow rate of the hydrogen.

Other objectives, advantages and features of the present invention will become apparent from the following description referring to the attached drawings.

### BRIEF DESCRIPTION OF THE DRAWINGS

The present invention will be described via detailed illustration of three embodiments referring to the drawings.

FIG. 1 is a block diagram of an apparatus for containing metal-organic frameworks according to the first embodiment of the present invention.

FIG. 2 is a block diagram of a fuel cell used with an apparatus for containing metal-organic frameworks according to the second embodiment of the present invention.

FIG. 3 is a block diagram of a fuel cell used with an apparatus for containing metal-organic frameworks according to the third embodiment of the present invention.

FIG. 4 is a cross-sectional view of a can of the apparatus shown in FIG. 1 for containing metal-organic frameworks in a first manner.

FIG. 5 is a cutaway view of the can of the apparatus shown in FIG. 1 for containing metal-organic frameworks in a second manner.

FIG. 6 is a cutaway view of the can of the apparatus shown in FIG. 1 for containing metal-organic frameworks in a third manner.

### DETAILED DESCRIPTION OF EMBODIMENT

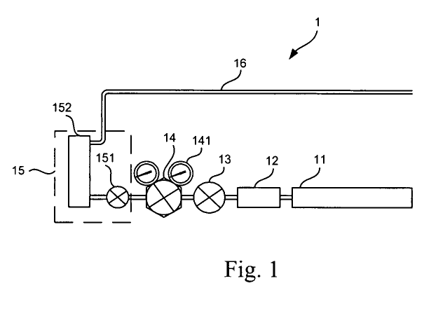

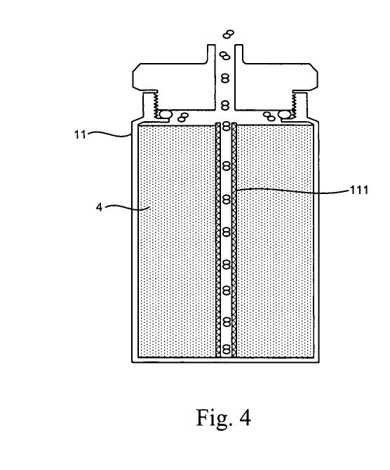

Referring to FIG. 1, shown is an apparatus 1 for containing metal-organic frameworks 4 (FIGS. 4 through 6) according to a first embodiment of the present invention. The apparatus can be used with a fuel cell.

The apparatus 1 includes a cartridge 11, a filter 12, a ball valve 13, a pressure regulator 15 and a pipe 16. The cartridge 11 is used to contain the metal organic frameworks 4.

The filter 12 is connected to the cartridge 11. The filter 12 is used to screen out powder of the metal-organic frameworks 4 entailed in the absorption and release of hydrogen by the cartridge 11.

The ball valve 13 is connected to the filter 12. The ball valve 13 is used to control the travel of the hydrogen from the cartridge 11.

The pressure regulator 14 is connected to the ball valve 13. The pressure regulator 14 includes two pressure gauges 141 for showing the pressure of the hydrogen from the cartridge 11.

The flow controller 15 is connected to the pressure regulator 14. The flow controller 15 includes a needle valve 151 connected to the pressure regulator 14 and a flow meter 152 connected to the needle valve 151. The flow meter 152 is used to show the flow rate of the hydrogen from the cartridge 11. The needle valve 151 is operable to adjust the flow rate of the hydrogen from the cartridge 11.

The pipe 16 includes an inlet connected to the flow meter 152.

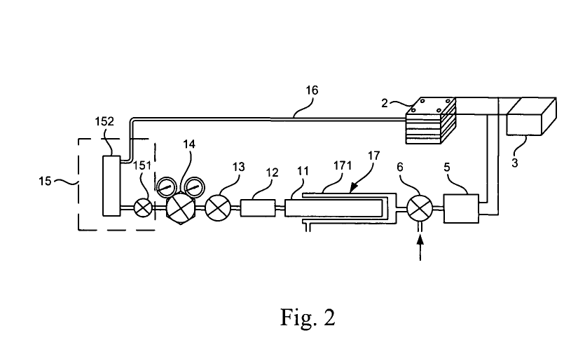

Referring to FIG. 2, a fuel cell is used with an apparatus according to a second embodiment of the present invention. The fuel cell includes a proton exchange membrane (“PEM”) fuel cell pack 2 formed with an anode inlet connected to an outlet of the pipe 16. A PID controller 5 is connected to the PEM fuel cell pack 2. A solenoid valve 6 is connected to the PID controller 5. A heater 17 is connected to the solenoid valve 6. The heater 17 includes a chamber 171 for containing the cartridge 11.

In operation, an electric load 13 is connected to the PEM fuel cell pack 2. Although not shown, a test station is used to monitor the open circuit voltage (“OCV”) of the fuel cell. If necessary, the heater 17 can be turned on to heat the cartridge 11 to increase the pressure or flow rate of the hydrogen traveling from the cartridge to the PEM fuel cell pack 2, thus increasing the voltage or power of the electricity generated by the fuel cell. More details of the heating of the cartridge 11 will be given.

The PEM fuel cell pack 2 generates heat as a byproduct that heats air around the fuel cell pack 2. The hot air is transferred into the chamber 171 under the control of the solenoid valve 6. The solenoid valve 6 is under the control of the PID controller 5. If the voltage or power of the electricity is much too low, i.e., the pressure or flow rate of the hydrogen is much too low, the PID controller 5 causes the solenoid valve 6 to open wide for a long period of time. Otherwise, the PID controller 5 causes the solenoid valve 6 to open less wide for a shorter period of time.

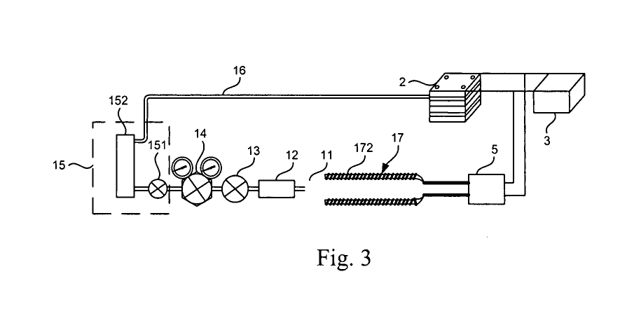

Referring to FIG. 3, the PEM fuel cell pack 2 is used with an apparatus according to a third embodiment of the present invention. The third embodiment is like the second embodiment except two things. Firstly, the heater 17 includes a heating wire or tape 172 instead of the heating chamber 171. Secondly, the solenoid valve 6 is omitted. The heating wire or tape 172 is under the control of the PID controller 5. If the voltage or power of the electricity is much too low, the PID controller 5 causes a large current to flow through the heating wire or tape 172 for a long period of time. Otherwise, the PID controller 5 causes a smaller current to flow through the heating wire or tape 172 for a shorter period of time.

Either one of the chamber 171 and the heating wire or tape 172 is able to provide heat to retain the temperature of the cartridge 11 within an appropriate range between 50 and 60 degrees Celsius. With the use of the heater 17 heating the cartridge 11, the apparatus 1 can release, in a large amount and at a high rate, hydrogen that cannot easily be at the normal temperature. Hence, the need for a stable voltage is satisfied.

Referring to FIG. 4, the metal-organic frameworks 4 are provided in a first manner. In the cartridge 11, two nets 111 are provided to define two compartments for containing the metal-organic frameworks 4. There is a gap between the compartments for the absorption and release of the hydrogen.

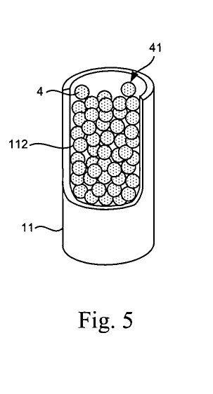

Referring to FIG. 5, the metal-organic frameworks 4 are provided in a second manner. A plurality of nets 112 is used. Each of the nets 112 contains a portion of the metal-organic frameworks 4 and therefore form a ball 41. The balls 41 are disposed in the cartridge 11. There are gaps between the balls 41 for the absorption and release of the hydrogen.

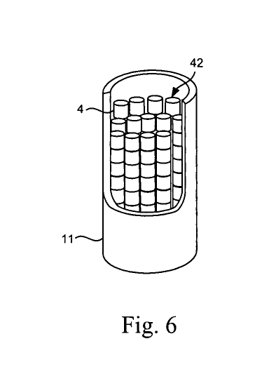

Referring to FIG. 6, the metal-organic frameworks 4 are provided in a third manner. The metal-organic frameworks 4 are divided into a plurality of portions. Each of the portions of the metal-organic frameworks 4 is formed into a cylinder by pressing molding. The cylinders are disposed in the cartridge 11. There are gaps between the cylinders for the absorption and release of the hydrogen.

Each of the above-mentioned manners is useful for increasing the rate of the release of the hydrogen. After a bridge-building process, the metal-organic frameworks 4 absorb 4.7 wt % of hydrogen at the normal temperature under 6.9 MPa.

As discussed above, the apparatus can release, in a large amount and at a high rate, hydrogen that cannot easily be at the normal temperature. Therefore, the fuel cells equipped with the apparatus 1 can provide stable voltages or powers of electricity. The structure of the apparatus 1 is simple. The operation of the apparatus 1 is easy. Moreover, in the fuel cell shown in FIG. 2, the cartridge 11 is heated by the heat that the PEM fuel cell pack 2 generates as a byproduct so that the cost of the operation is low.

The present invention has been described via the detailed illustration of the embodiments. Those skilled in the art cartridge derive variations from the embodiments without departing from the scope of the present invention. Therefore, the embodiments shall not limit the scope of the present invention defined in the claims.

1. An apparatus for containing metal-organic frameworks for storing hydrogen for use in a fuel cell, the apparatus comprising:
a cartridge for containing the metal-organic frameworks;
a filter connected to the cartridge for filtering out powder of the metal-organic frameworks during the release of the hydrogen;
a ball valve connected to the filter for controlling the travel of the hydrogen;
a pressure regulator connected to the ball valve for regulating the pressure of the hydrogen;
a flow controller connected to the pressure regulator for controlling the flow rate of the hydrogen, the flow controller comprising a flow meter for showing the flow rate of the hydrogen and a needle valve operable for changing the flow rate of the hydrogen; and
a pipe connected to the flow controller on one hand and connected to the fuel cell on the other hand for providing the hydrogen to the fuel cell.

2. The apparatus according to claim 1 comprising two nets disposed in the cartridge, thus separating the cartridge into two compartments for containing the metal-organic frameworks.

3. The apparatus according to claim 2, wherein there is a gap between the compartments.

4. The apparatus according to claim 1 comprising a plurality of nets each for containing a portion of the metal-organic frameworks, thus forming a ball, and the balls are disposed in the cartridge.

5. The apparatus according to claim 4, wherein there are gaps between the balls.

6. The apparatus according to claim 1, wherein the metal-organic frameworks are divided into a plurality of portions each formed into a cylinder by a pressing molding process, and the cylinders are disposed in the cartridge.

7. The apparatus according to claim 6, wherein there are gaps between the cylinders.

8. The apparatus according to claim 1 comprising a heater for heating the cartridge.

9. The apparatus according to claim 8 comprising a PID controller for controlling the heater.

10. The apparatus according to claim 9, wherein the heater comprises a heating wire connected to the PID controller and provided around the cartridge so that a current is provided to the heating wire under the control of the PID controller.

11. The apparatus according to claim 9, wherein the heater comprises:
a chamber for containing the cartridge; and
a solenoid valve connected to the PID so that a current is provided to the solenoid valve under the control of the PID controller and in communication with the chamber so that hot air travels from the fuel cell into the chamber for heating the cartridge under the control of the solenoid valve.

12. The apparatus according to claim 1, wherein the pressure regulator comprises two pressure gauges.
